(19) United States
(12) Patent Application Publication
(10) Pub. No.: US 2020/0159762 A1
(43) Pub. Date: May 21, 2020

(54) INTEREST-BASED AND BIBLIOGRAPHICAL DATA-BASED MULTIMEDIA CONTENT EXPLORATION, CURATION AND ORGANIZATION

(71) Applicant: Push Through Innovation Corporation, Marietta, GA (US)

(72) Inventor: Austin Webster, Marietta, GA (US)

(21) Appl. No.: 16/618,594

(22) PCT Filed: Jun. 1, 2018
(86) PCT No.: PCT/US18/35750

§ 371 Date: Dec. 2, 2019

Related U.S. Application Data
(60) Provisional application No. 62/513,704, filed on Jun. 1, 2017.

(51) Int. Cl. G06F 16/438; G06F 16/44; G06F 16/435; G06F 16/48

(52) U.S. Cl. CPC G06F 16/4393; G06F 16/48; G06F 16/435; G06F 16/44

(57) ABSTRACT

An Interest-Based and Bibliographical Data-Based Multimedia Content Exploration, Curation, and Organization Method is provided. In one aspect the present disclosure is a method for identifying a multimedia track, wherein the multimedia track comprises at least one of the following media: audio, video, and encoding type. In another aspect, the present disclosure is a method for generating at least one playlist comprising at least one multimedia track. In another aspect, the present disclosure is a method enabling a platform operating on a computing to device to perform steps including identifying a multimedia track; determining bibliographical data associated with the identified track; receiving indications of parameters of interest; generating, based on at least one parameter of interest, at least one playlist comprised of at least one additional multimedia track; and retrieving data associated with the multimedia track.

### RELATED APPLICATION

The present application is a U.S. National Stage under 35 U.S.C. § 371 of International Application No. PCT/US2018/035750, filed on Jun. 1, 2018, which claims benefit under the provisions of 35 U.S.C. § 119(e) of U.S. Provisional Application No. 62/513,704 entitled “Interest-Based and Bibliographical Data-Based Multimedia Content Exploration, Curation and Organization,” filed Jun. 1, 2017, and having inventors in common, which are incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to the curation of organized multimedia content based on an exploration of common parameters of interest associated with the multimedia content.

### BACKGROUND

There are currently an estimated 937 million digital music listeners world-wide. Of those listeners, 18 million pay for a music streaming service in the US. However, in the current digital music era, it has become increasingly difficult to quickly access song credits for music and utilize that information to find new music. Recent surveys have found that 54% of respondents read the bio of the artist they are listening to when streaming music, and that 45.8% of respondents search for song or album credits when streaming music.

It was further found that 48.1% of respondents search for songs by producers or studio musicians and that 62% of respondents believe playlists are important to the streaming music experience. Thus, in view of the market demand, it may be concluded that there exists a need to enable users to generate personalized playlists based on credential data for the music.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

The platform enables users to quickly discover, curate, and enjoy data and playlists based on various multimedia credit criteria. The platform may first identify a multimedia track. Identification may begin with, in some instances, the receiving of an audio signal associated with the track. The audio signal may be received from, for example, a microphone. The platform may then cross reference a plurality of databases to associate the audio signal received with the corresponding track data. In this way, the platform may retrieve data associated with, for example, but not limited to, a song title, artist title, and an album title for the identified track.

Having identified the track, the platform may enable a user to explore various bibliographical data associated with the track. In order to facilitate the exploration process, the platform may be enabled to determine a plurality of parameters associated with the identified track. The parameters may comprise, for example, but not be limited to, producers, artists, albums, composers, engineers, mixers, studios, labels, musicians, and other related data points associated with the track.

The parameters may then be compiled into options that a user of the platform may indicate to be of interest. Receiving selection of the options corresponding to the parameters may indicate that the user is interested in curating a playlist comprising other tracks associated with the same parameters of interest. Further still, in addition to the presented parameters, the platform may enable a user to explore credit and biographical data associated with the identified track. In this way, the platform may enable a user to both study the credentials associated with a track and select those credentials that are of interest in exploring further.

Consistent with embodiments of the present disclosure, the platform may facilitate an exploration based on the provision of related tracks aggregated from, for example, another track's bibliographical data determined to be of interest to the user. In this way, the platform may provide users with playlists containing tracks related to those parameters determined to be of interest. First, the platform may match the parameters of interest to related tracks having the same parameters. In some instances, this may be done by cross referencing a plurality of multimedia databases. Once the tracks associated with the same parameters have been identified, they may be compiled into at least one playlist.

The playlists may be presented to the user. The user may stream, purchase, and explore at least one of the tracks in the playlist in the same way the user was enabled to explore the parameters associated with the identified track. The platform may further enable a user to mix and match various parameters into different playlists. The playlists may be saved for later retrieval.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a flow chart of a method consistent with embodiments of the present disclose;

FIG. 3 illustrates aspects of the method and system consistent with embodiments of the present disclose;

FIG. 4 illustrates aspects of the method and system consistent with embodiments of the present disclose;

FIG. 5 illustrates aspects of the method and system consistent with embodiments of the present disclose;

FIG. 6 illustrates aspects of the method and system consistent with embodiments of the present disclose;

FIG. 7 illustrates aspects of the method and system consistent with embodiments of the present disclose;

FIG. 8 illustrates aspects of the method and system consistent with embodiments of the present disclose;

FIG. 9 illustrates aspects of the method and system consistent with embodiments of the present disclose;

FIG. 10 illustrates aspects of the method and system consistent with embodiments of the present disclose;

FIG. 11 illustrates aspects of the method and system consistent with embodiments of the present disclose;

FIG. 12 is a block diagram of a system including a computing device for performing the method of FIG. 2; and

FIGS. 13A, 13B, 13C, 13D, and 14 illustrate a flow chart of a method consistent with embodiments of the present disclose.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of audio tracks, embodiments of the present disclosure are not limited to use only in this context. For example, video track exploration, curation, and organization may be based on the same general embodiments disclosed herein.

I. Platform Configuration

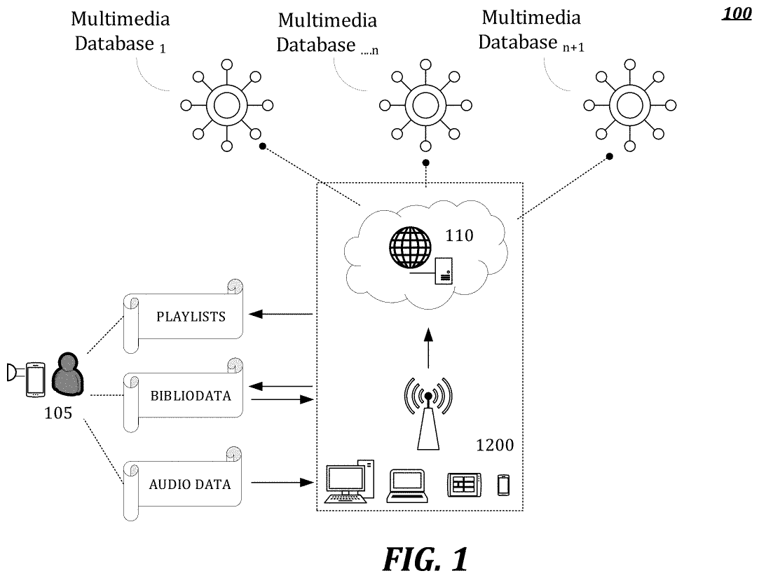

Consistent with embodiments of the present disclosure, a platform for music exploration, curation, and organization may be provided. FIG. 1 illustrates one possible operating environment through which a platform consistent with embodiments of the present disclosure may be provided. By way of non-limiting example, platform 100 may be hosted on a centralized server 110, such as, for example, a cloud computing service. A user 105 may access platform 100 through a software application. The software application may be embodied as, for example, but not be limited to, a website, a web application, a desktop application, and a mobile application compatible with a computing device 1200. One possible embodiment of the software application may be provided by the Deepr™ or NoteXplore™ suite of products and services provided by Push Through Innovation Corporation.

In some embodiments, user 105 may use a mobile computing device to provide audio data associated with a multimedia track to platform 100. The audio data may be processed by server 110 in accordance to method 200 and return bibliographical data to user 105. User 105 may then study the bibliographical data, and select parameters associated with the bibliographical data as reference points for the curation of additional multimedia tracks. The selected parameters may be returned to server 110, that will cross reference the parameters with a plurality of multimedia databases in order to match multimedia tracks that may also be associated with the same parameters. The matched tracks may then be presented to user 105 as playlists curated based on the user's selected parameters.

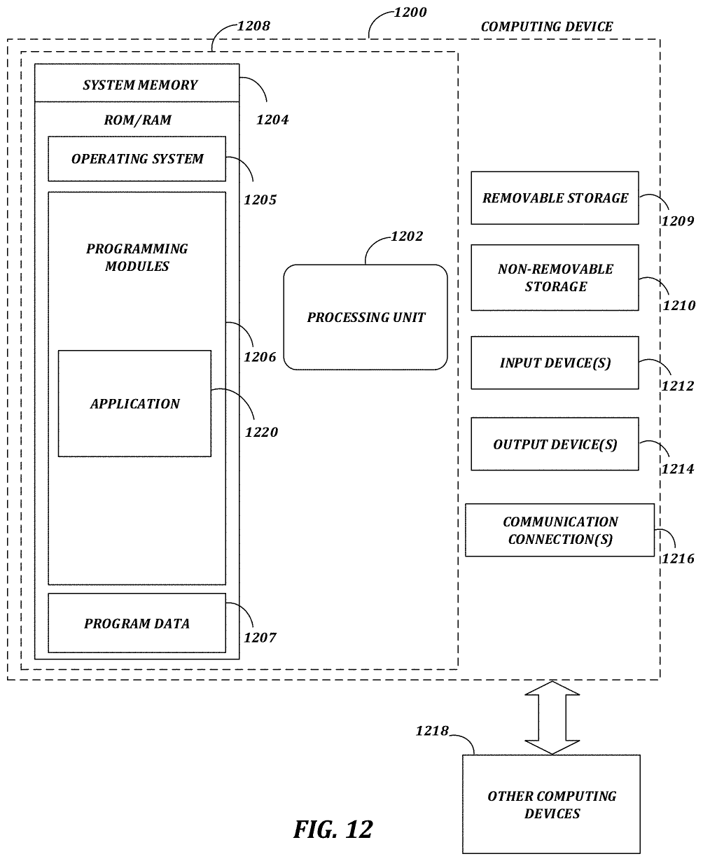

As will be detailed with reference to FIG. 12 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein. Moreover, although certain operations have been disclosed to be performed by server 110, it should be understood that the same operations may be performed on a computing device locally associated with user 105.

II. Platform Operation

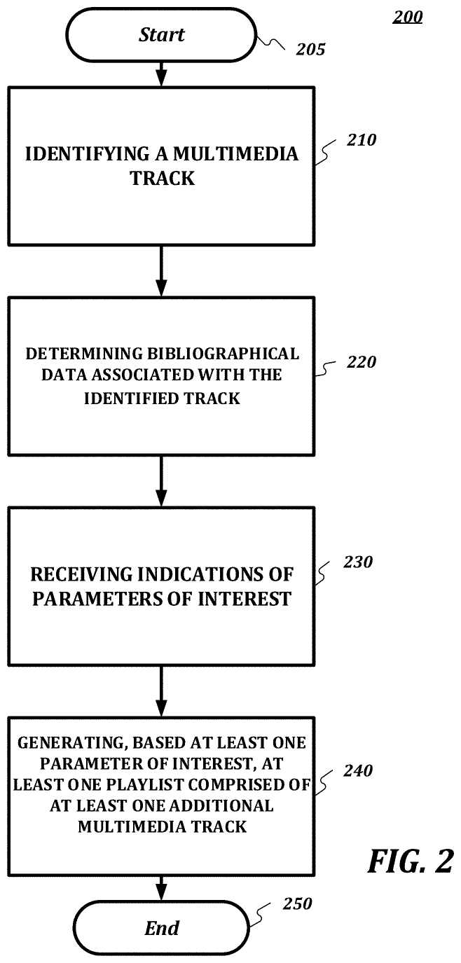

FIG. 2 is a flow chart setting forth the general stages involved in a method 200 consistent with an embodiment of the disclosure for providing platform 100. Method 200 may be implemented using a computing device 1200 as described in more detail below with respect to FIG. 12.

Although method 200 has been described to be performed by platform 100, it should be understood that computing device 1200 may be used to perform the various stages of method 200. Furthermore, in some embodiments, different operations may be performed by different networked elements in operative communication with computing device 1200. For example, server 110 may be employed in the performance of some or all of the stages in method 200. Moreover, server 110 may be configured much like computing device 1200.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 200 will be described in greater detail below.

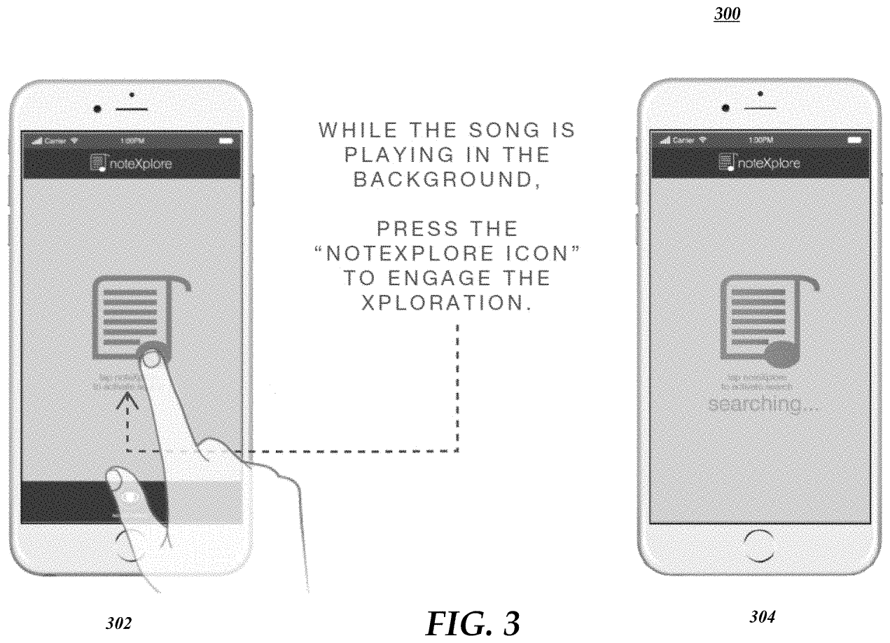

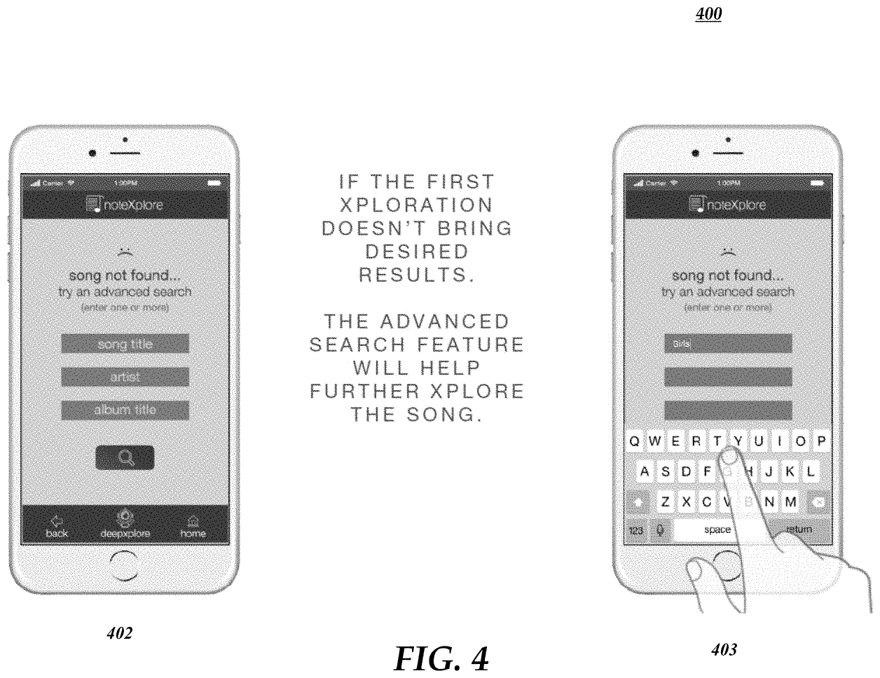

Method 200 may begin at starting block 205 and proceed to stage 210 where computing device 1200 may identify a multimedia track. FIGS. 3-4 illustrate an embodiment for multimedia track identification. The multimedia track may be, for example, but not limited to an audio track, a video track, or any combination thereof at any encoding type.

The multimedia track may be provided by the user in a plurality of ways. For example, the user may provide the multimedia track as an audio signal to platform 100. The user may provide a selection to engage a microphone of, for example, a mobile computing device operating the Deepr™ or NoteXplore™ software application. The mobile computing device may be enabled to record and/or stream a signal received from the microphone to server 110. Server 110 may, in turn, process the signal to determine an identify of the multimedia track. In the process, server 110 may be configured to access a plurality of music databases, comprising, but not limited to,
ACRCloud
AcoustID
OneMusicAPI
MusicGraph
Discogs
Genius

Access to the databases from server 110 may be enabled by different application programming interface (API) systems and methods. By cross referencing the audio data with the data of at least one multimedia database, platform 100 may be enabled to identify the multimedia track by, for example, but not limited to, song title, album title, and artist name.

In some embodiments, user 105 need not provide audio data via microphone input. Rather, platform 105 may enable user 105 to manually input the data for the multimedia track, such as, for example, the song title, album title, and artist name. Consistent with embodiments of the present disclosure, both manual entry and audio data input may coexist to ensure a more accurate and precise identification of the multimedia track.

From stage 210, where computing device 1200 has identified the multimedia track, method 200 may advance to stage 220 where computing device 1200 may determine bibliographical data associated with the identified track. The bibliographical data may comprise a plurality of parameters corresponding to the identified track. The data may be retrieved by server 110 from a plurality of music databases as disclosed with reference to FIG. 1. The plurality of parameters may include, for example, but not be limited to:
Producers associated with the multimedia track,
Artists associated with the multimedia track,
Albums associated with the multimedia track,
Composers associated with the multimedia track,
Engineers associated with the multimedia track,
Mixers associated with the multimedia track,
Mastering associated with the multimedia track,
Recording Studios associated with the multimedia track,
Musicians associated with the multimedia track,
Record labels associated with the multimedia track,
Timelines associated with the multimedia track,
Samples associated with the multimedia track, and
Interpolations associated with the multimedia track.

Once computing device 1200 determines the plurality of parameters in stage 220, method 200 may continue to stage 230 where computing device 1200 may present the plurality of parameters to receive indications of parameters of interest.

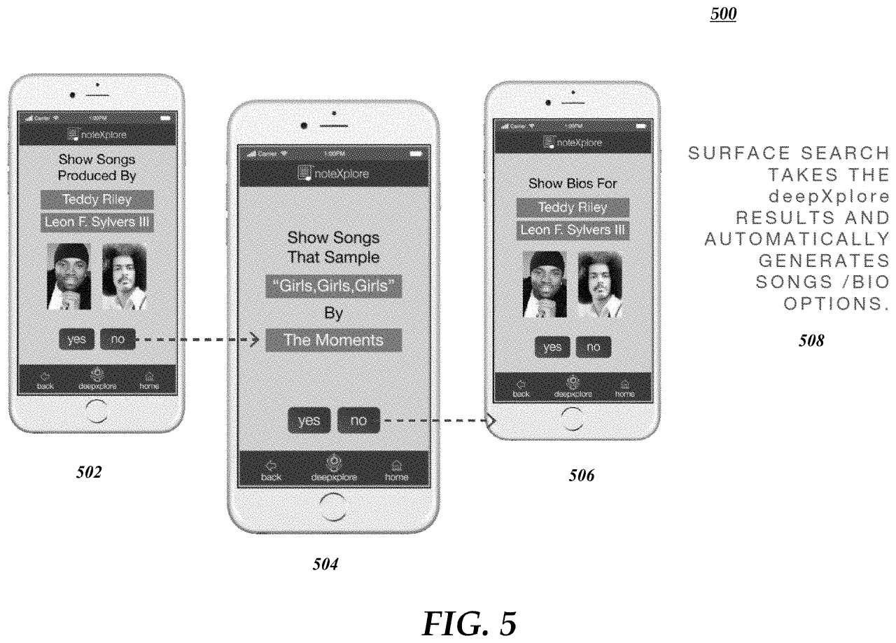

In some embodiments, parameters may be presented as a plurality of selectable options associated with the plurality of parameters in successive order. FIG. 5 illustrates one possible embodiment of presenting the options. Each option may correspond to a parameter associated with the identified multimedia track. Platform 100 may enable user 105 to provide an indication of interest for each parameter presented as a selectable option. In some embodiments, the response may be provided via a selection of user-interface element corresponding to, for example, ‘interested’, ‘not interested’, or ‘neither’. In other embodiments, other systems and methods may be employed to derive interest indication.

Once user 105 has provided an indication of interest, a subsequent selectable option corresponding to a subsequent parameter associated with the identified track may be provided. In turn, user 105 may provide their interest indication to the subsequent option. In this way, platform 100 may determine a plurality of parameters of interest based on the received responses to the selectable options. The presentation of options may continue until platform 100 has sufficient data to present an aggregated playlist to user 105 in stage 240.

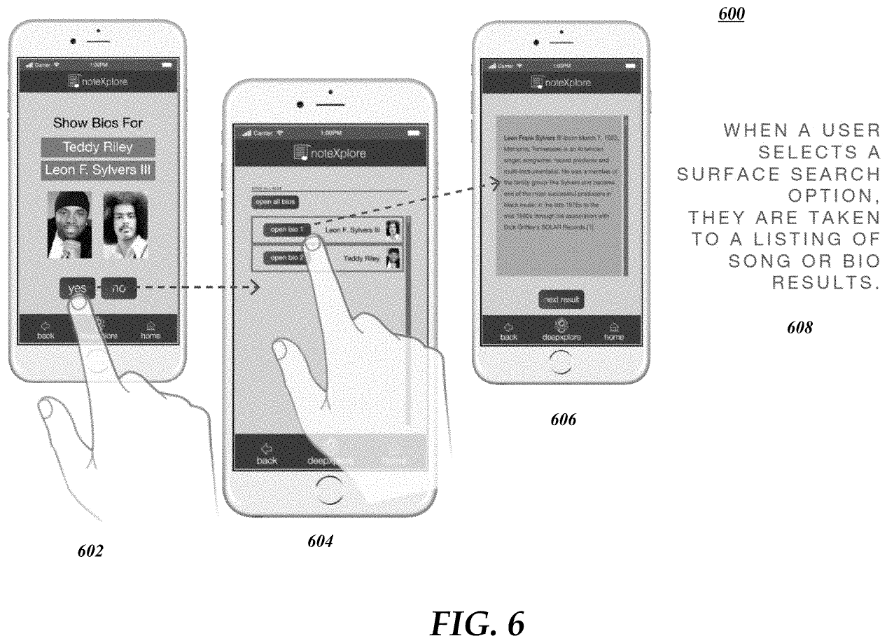

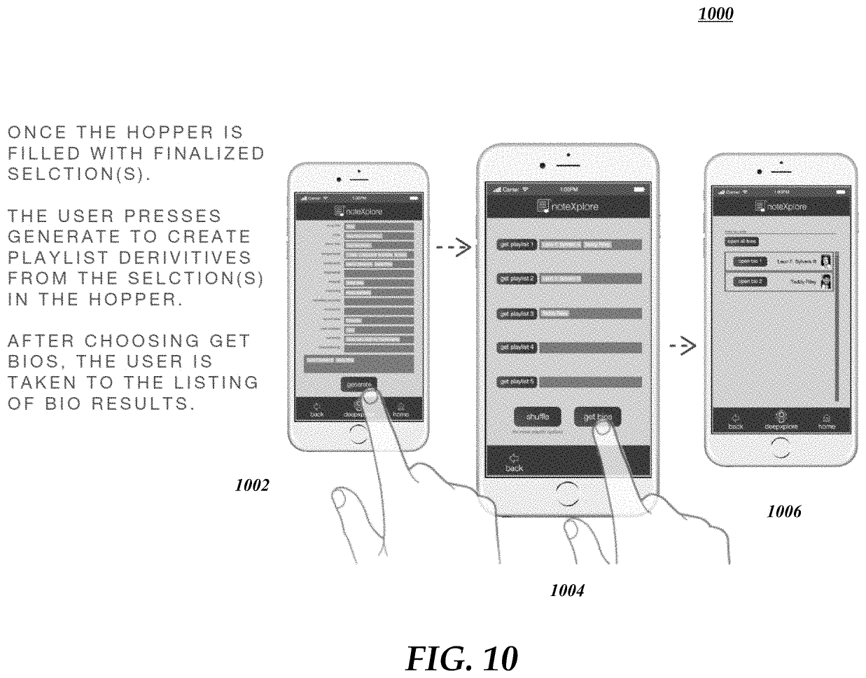

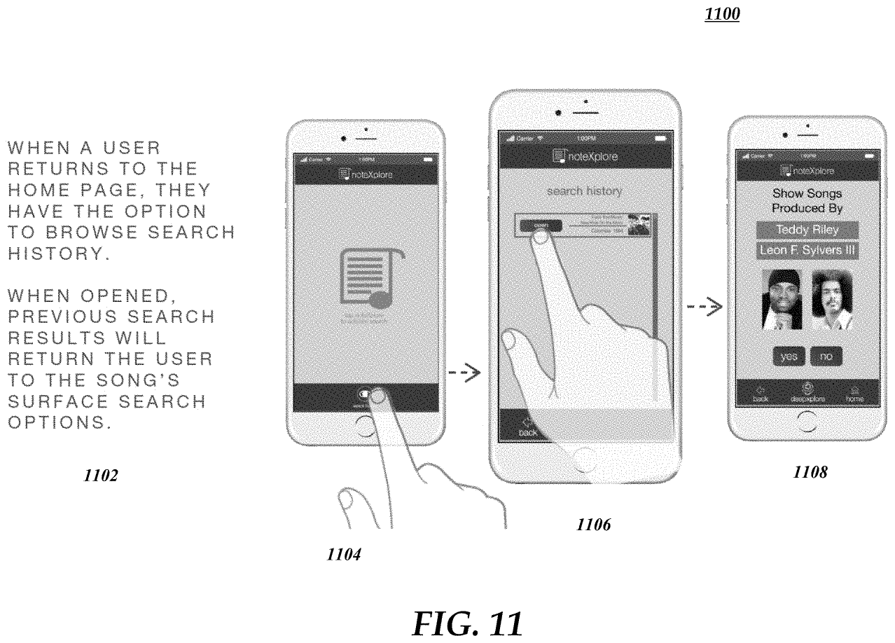

Still consistent with embodiments of the present disclosure, the presentation of selectable options to user 105 may include text and images associated with the parameters. The text and images may provide, for example, a biography and pictures of at least one person associated with the identified track. The additional data conveyed by the text and images may be retrieved by server 110 from a plurality of music databases as disclosed with reference to FIG. 1. FIGS. 6 and 10 illustrate possible embodiments of presenting additional information associated with the identified track.

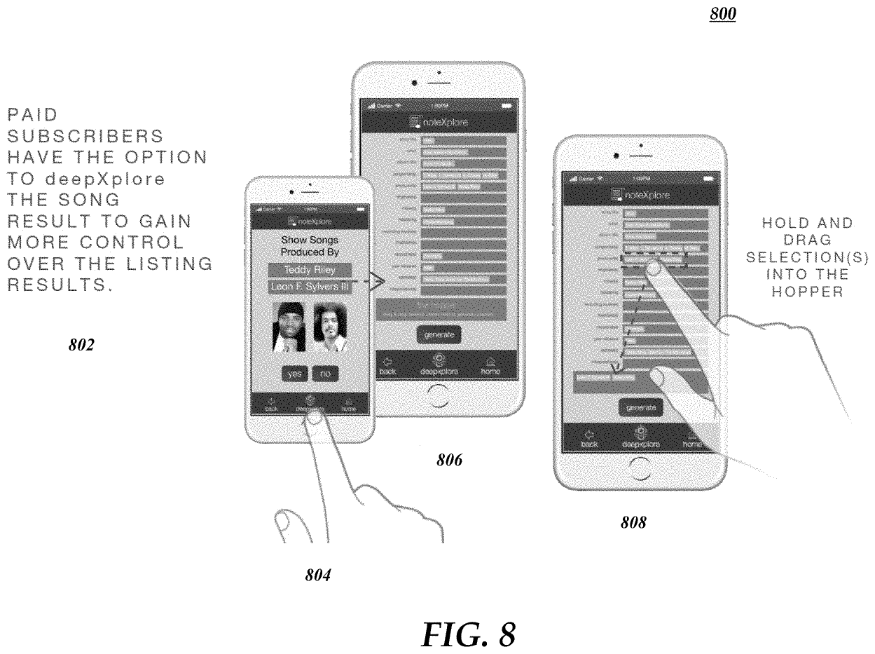

FIG. 8 illustrates yet further embodiments of receiving indications of parameters of interest. As shown in FIG. 8, platform 100 may present a plurality of parameters to user 105. Unlike the embodiment of FIG. 6, however, user 105 may be enabled to select at least one of the parameters directly to ‘tag’ those parameters as parameters of interest. In this way, platform 100 may determine a plurality of parameters of interest based on the received responses to the selectable options. The presentation of options may continue until platform 100 has sufficient data to present an aggregated playlist to user 105 in stage 240.

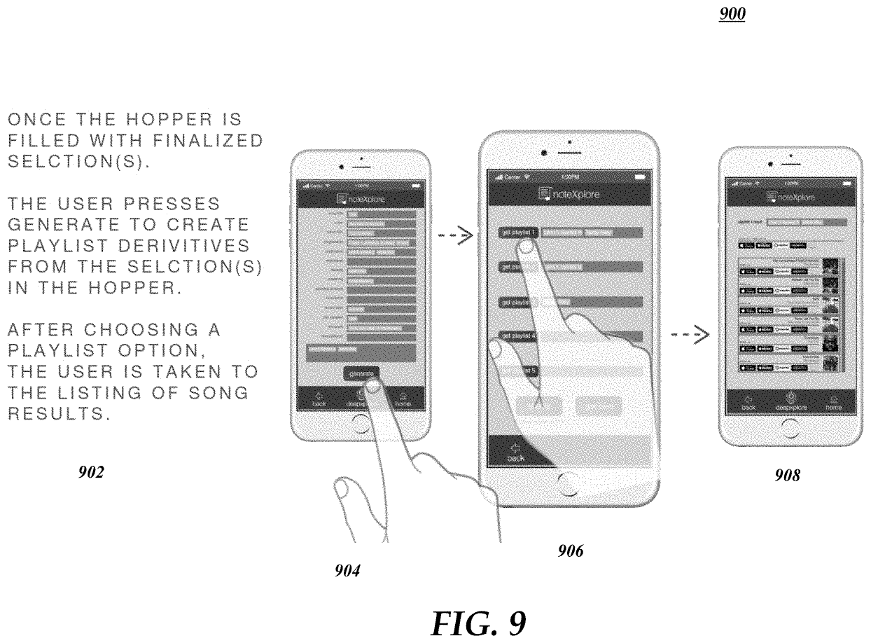

In some embodiments, the selected parameters may be mixed and matches. FIG. 9 illustrates how various parameters of interest can be combined into separate playlists. Platform 100 may enable the dynamic reorganization the parameters such that the resulting tracks of each playlist correspond to the selected parameters for the playlist.

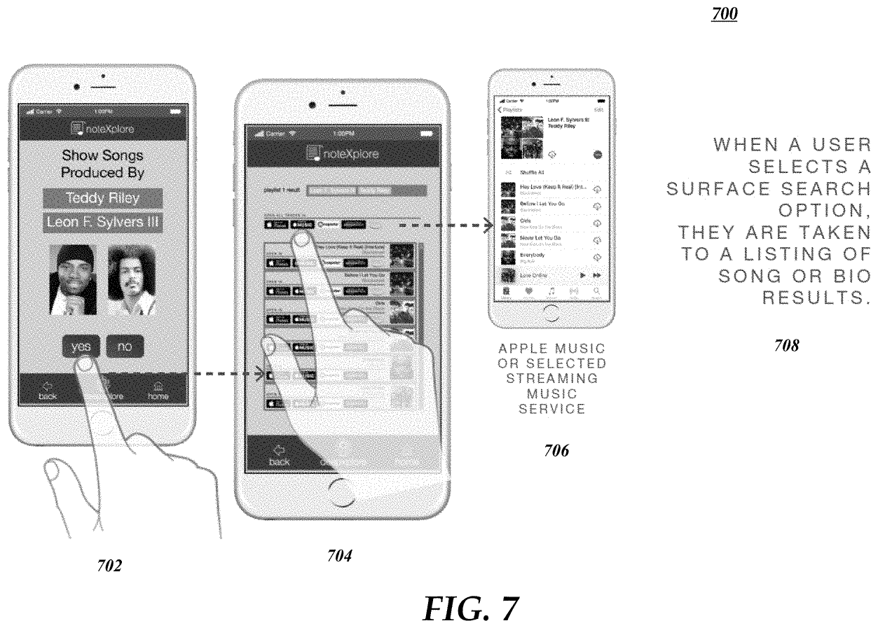

After computing device 1200 has established the parameters of interest in stage 230, method 200 may proceed to stage 240 where computing device 1200 may generate, based at least one parameter of interest, at least one playlist comprised of at least one additional multimedia track. FIGS. 7 and 9 illustrate at least one playlist that may be generated by platform 100.

To retrieve at least one additional track, platform 100 may access a plurality of music databases, via server 110, as disclosed with reference to FIG. 1. The platform may parse through parameters associated with each of the tracks in the music databases. In the process, matching tracks may be identified. For example, at least one additional multimedia track may be considered to match when at least a portion of the plurality of parameters corresponds associated with the additional track correspond to at least one parameter of interest. In some embodiments, the quantity of parameters that must match for each playlist may be predefined and correspond to a threshold match level (e.g., if ⅔ parameters match, then the additional track is considered to be a match.)

Once the matches for each playlist are identified, the at least one playlist may be presented. Consistent with embodiments of the present disclosure, the presentation of the playlist by platform 100 may comprise, but not be limited to: 1) enabling a streaming of at least one of the tracks in the playlist (by means of, for example, but not limited to, third party integrations), and 2) enabling a purchasing of at least one of the tracks in the playlist (by means of, for example, but not limited to, third party integrations).

Further still, in some embodiments, the presentation of each playlist may further enable users to view bibliographical data associated with each track in the playlist (e.g., text and images associated with people related to the tracks). Moreover, as disclosed with references to the stages above, the bibliographical data may be broken down into selectable parameters. Accordingly, platform 100 may enable users to select parameters of interest to be associated with the playlist based on the parameters of tracks within the playlist.

For example, platform 100 may be configured to enable a presentation of at least one parameter associated with at least one of the tracks in the playlist and, then, enable user 105 to provide subsequent indications of parameters of interested based on the parameters associated with at least one of the tracks in the playlist. In turn, the subsequent indications of parameters of interest may enable the generation of an updated and/or additional playlist in accordance to the embodiments disclosed herein.

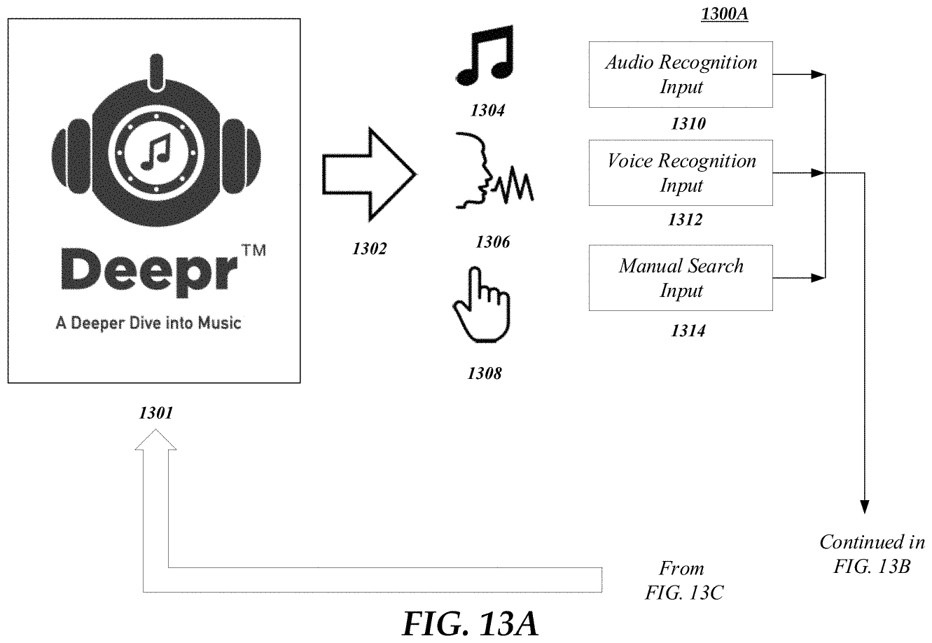

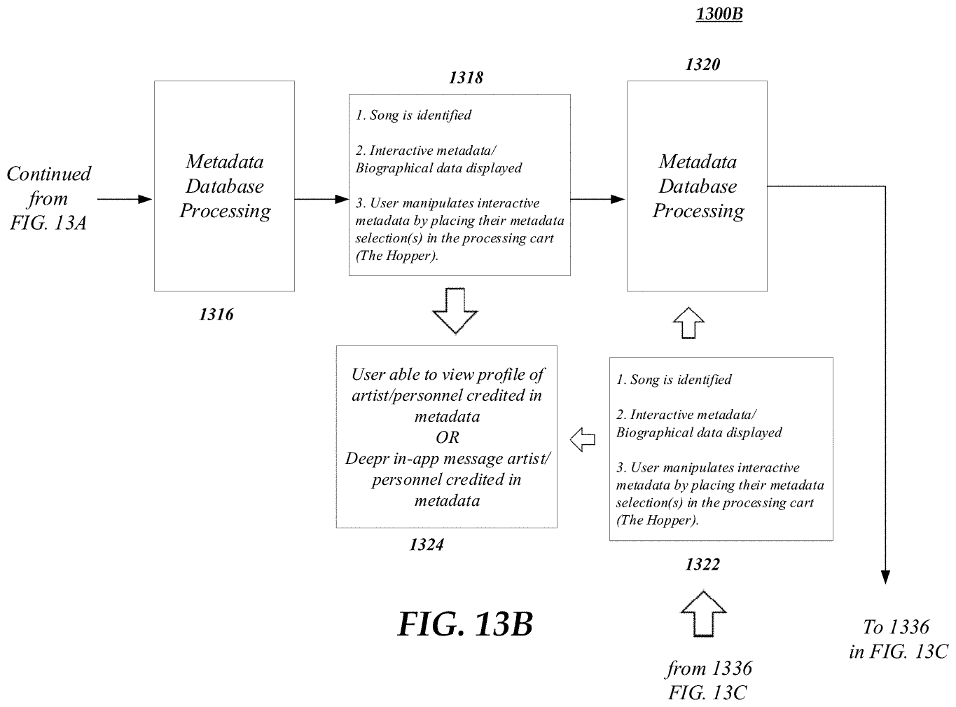

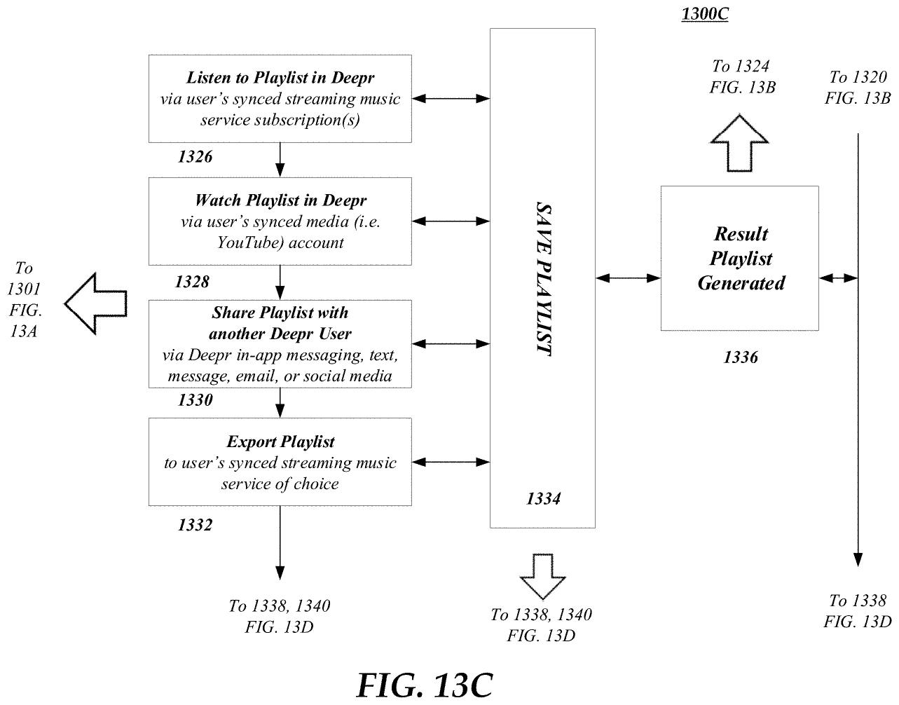

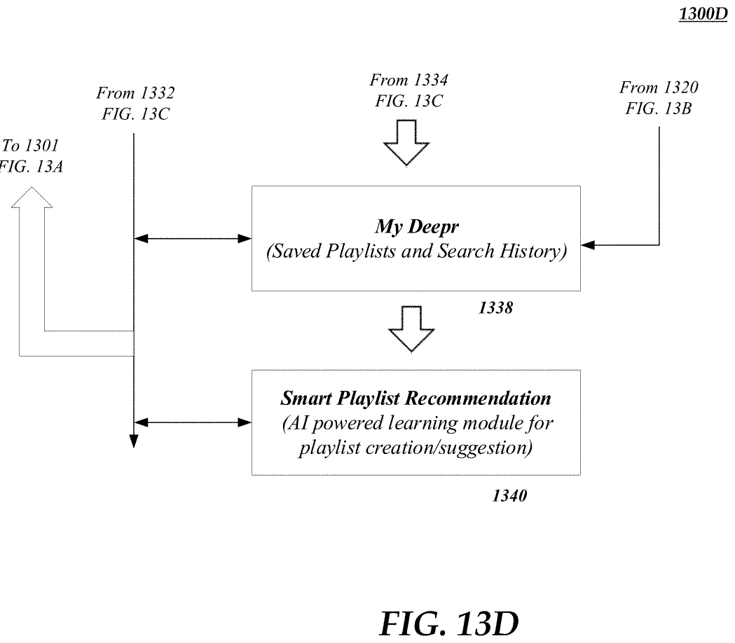

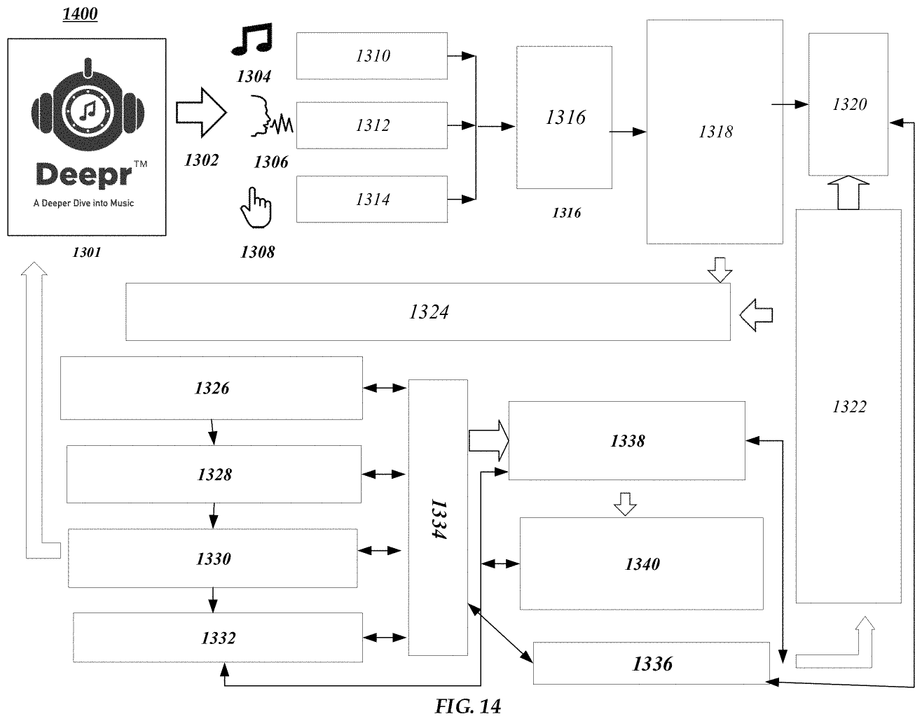

FIG. 14 is an overview of flow chart setting forth the general stages involved in a method 1300 consistent with an embodiment of the disclosure for providing platform 100. FIG. 13A, 13B, 13C, 13D breakdown the general stages of the flow chart in detail for method 1300. Method 1300 may be implemented using a computing device 1200 as described in more detail below with respect to FIG. 12.

Although method 1300 has been described to be performed by platform 100, it should be understood that computing device 1200 may be used to perform the various stages of method 1300. Furthermore, in some embodiments, different operations may be performed by different networked elements in operative communication with computing device 1200. For example, server 110 may be employed in the performance of some or all of the stages in method 1300. Moreover, server 110 may be configured much like computing device 1200.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 1300 will be described in greater detail below.

Method 1300 may begin at starting block 1301 and proceed to stage 1302 where a user may select a multimedia track by a computing device 1200 receiving multimedia data type track 1304 using audio recognition input 1310; receiving an audio signal at a microphone input 1306 processing voice recognition input 1312; and a keyboard, a pen, or a touch input device 1308 providing a manual search input 1314 as shown in FIG. 13A. The multimedia track may be, for example, but not limited to an audio track, a video track, or any combination thereof at any encoding type.

The multimedia track may be provided by the user in a plurality of ways. For example, the user may provide the multimedia track as an audio signal to platform 100. The user may provide a selection to engage a microphone of, for example, a mobile computing device operating Deepr™ or NoteXplore™ software application. The mobile computing device may be enabled to record and/or stream a signal received from the microphone to server 110. Server 110 may, in turn, process the signal to determine an identify of the multimedia track. In the process, server 110 may be configured to access a plurality of music databases, comprising, but not limited to:
ACRCloud
AcoustID
OneMusicAPI
MusicGraph
Discogs
Genius

Access to the databases from server 110 may be enabled by different application programming interface (API) systems and methods. By cross referencing the audio data with the data of at least one multimedia database, platform 100 may be enabled to identify the multimedia track by, for example, but not limited to, song title, album title, and artist name.

In some embodiments, user 105 need not provide audio data via microphone input. Rather, platform 105 may enable user 105 to manually input the data for the multimedia track, such as, for example, the song title, album title, and artist name. Consistent with embodiments of the present disclosure, both manual entry and audio data input may coexist to ensure a more accurate and precise identification of the multimedia track.

From input stage 1310, 1312, or 1314, where computing device 1200 has identified the multimedia track, method 1300 may advance to stage 1316 where computing device 1200 may being metadata database processing 1316 prior to advancing to a method of song identification, determining bibliographical data associated with the identified track, and manipulating the interactive metadata selections all in stage 1318. The bibliographical data may comprise a plurality of parameters corresponding to the identified track. The data may be retrieved by server 110 from a plurality of music databases as disclosed with reference to FIG. 1. The plurality of parameters may include, for example, but not be limited to:
Producers associated with the multimedia track,
Artists associated with the multimedia track,
Albums associated with the multimedia track,
Composers associated with the multimedia track,
Engineers associated with the multimedia track,
Mixers associated with the multimedia track,
Mastering associated with the multimedia track,
Recording Studios associated with the multimedia track,
Musicians associated with the multimedia track,
Record labels associated with the multimedia track,
Timelines associated with the multimedia track,
Samples associated with the multimedia track, and
Interpolations associated with the multimedia track.

Once computing device 1200 has advanced to a method of song identification, determining bibliographical data associated with the identified track, and manipulating the interactive metadata selections in stage 1318, method 1300 may continue to stage 1320 for more metadata database processing prior to advancing to stage 1322 where computing device 1200 may again perform a method of song identification, determining bibliographical data associated with the identified track, and manipulating the interactive metadata selections. The computing device 1200 may then advance to stage 1324 wherein the computing device 1200 may display a profile of artist and/or personnel metadata relating to the identified multimedia track; At stage 1324, computing device 1200 may provide a Deepr™ in-app message for artist and/or personnel credited metadata relating to the identified multimedia track.

In some embodiments, parameters may be presented as a plurality of selectable options associated with the plurality of parameters in successive order. FIG. 5 illustrates one possible embodiment of presenting the options. Each option may correspond to a parameter associated with the identified multimedia track. Platform 100 may enable user 105 to provide an indication of interest for each parameter presented as a selectable option. In some embodiments, the response may be provided via a selection of user-interface element corresponding to, for example, ‘interested’, ‘not interested’, or ‘neither’. In other embodiments, other systems and methods may be employed to derive interest indication.

From Metadata Database Processing stage 1320, where computing device 1200 has identified the multimedia track, method 1300 may advance to stage 1336 where computing device 1200 may generate a result playlist. From Metadata Database Processing stage 1320, where computing device 1200 has identified the multimedia track, method 1300 may advance to stage 1338 where the computing device 1200 may store the saved playlist using the platform 100 at stage 1338 prior to advancing to a beginning of method 1300 at stage 1301. The result playlist may be saved at stage 1334. After the playlist is saved at stage 1334, there are a number of options available to the user 105. The user may listen to the playlist using the platform 100 at stage 1326 prior to advancing to a beginning of method 1300 at stage 1301. The user may watch the playlist using the platform 100 at stage 1328 prior to advancing to a beginning of method 1300 at stage 1301. The user may share the playlist using the platform 100 at stage 1330 prior to advancing to a beginning of method 1300 at stage 1301. The user may export the playlist using the platform 100 at stage 1332 prior to advancing to a beginning of method 1300 at stage 1301. The computing device 1200 may store the saved playlist using the platform 100 at stage 1338 prior to advancing to a beginning of method 1300 at stage 1301. The computing device 1200 may provide a smart playlist recommendation using the platform 100 at stage 1340 prior to advancing to a beginning of method 1300 at stage 1301.

Further still, in some embodiments, the presentation of each playlist may further enable users to view bibliographical data associated with each track in the playlist (e.g., text and images associated with people related to the tracks). Moreover, as disclosed with references to the stages above, the bibliographical data may be broken down into selectable parameters. Accordingly, platform 100 may enable users to select parameters of interest to be associated with the playlist based on the parameters of tracks within the playlist.

For example, platform 100 may be configured to enable a presentation of at least one parameter associated with at least one of the tracks in the playlist and, then, enable user 105 to provide subsequent indications of parameters of interested based on the parameters associated with at least one of the tracks in the playlist. In turn, the subsequent indications of parameters of interest may enable the generation of an updated and/or additional playlist in accordance to the embodiments disclosed herein.

III. Platform Architecture

Platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, platform 100 may be hosted on a centralized server, such as, for example, a cloud computing service. Although method 200 has been described to be performed by a computing device 1200, it should be understood that, in some embodiments, different operations may be performed by different networked elements in operative communication with computing device 1200.

Embodiments of the present disclosure may comprise a system having a memory storage and a processing unit. The processing unit coupled to the memory storage, wherein the processing unit is configured to perform the stages of method 200.

FIG. 12 is a block diagram of a system including computing device 1200. Consistent with an embodiment of the disclosure, the aforementioned memory storage and processing unit may be implemented in a computing device, such as computing device 1200 of FIG. 12. Any suitable combination of hardware, software, or firmware may be used to implement the memory storage and processing unit. For example, the memory storage and processing unit may be implemented with computing device 1200 or any of other computing devices 1218, in combination with computing device 1200. The aforementioned system, device, and processors are examples and other systems, devices, and processors may comprise the aforementioned memory storage and processing unit, consistent with embodiments of the disclosure.

With reference to FIG. 12, a system consistent with an embodiment of the disclosure may include a computing device, such as computing device 1200. In a basic configuration, computing device 1200 may include at least one processing unit 1202 and a system memory 1204. Depending on the configuration and type of computing device, system memory 1204 may comprise, but is not limited to, volatile (e.g. random access memory (RAM)), non-volatile (e.g. read-only memory (ROM)), flash memory, or any combination. System memory 1204 may include operating system 1205, one or more programming modules 1206, and may include a program data 1207. Operating system 1205, for example, may be suitable for controlling computing device 1200's operation. In one embodiment, programming modules 1206 may include application 1220. Furthermore, embodiments of the disclosure may be practiced in conjunction with a graphics library, other operating systems, or any other application program and is not limited to any particular application or system. This basic configuration is illustrated in FIG. 12 by those components within a dashed line 1208.

Computing device 1200 may have additional features or functionality. For example, computing device 1200 may also include additional data storage devices (removable and/or non-removable) such as, for example, magnetic disks, optical disks, or tape. Such additional storage is illustrated in FIG. 12 by a removable storage 1209 and a non-removable storage 1210. Computer storage media may include volatile and nonvolatile, removable and non-removable media implemented in any method or technology for storage of information, such as computer readable instructions, data structures, program modules, or other data. System memory 1204, removable storage 1209, and non-removable storage 1210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1200. Any such computer storage media may be part of device 1200. Computing device 1200 may also have input device(s) 1212 such as a keyboard, a mouse, a pen, a sound input device, a touch input device, etc. Output device(s) 1214 such as a display, speakers, a printer, etc. may also be included. The aforementioned devices are examples and others may be used.

Computing device 1200 may also contain a communication connection 1216 that may allow device 1200 to communicate with other computing devices 1218, such as over a network in a distributed computing environment, for example, an intranet or the Internet. Communication connection 1216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1204, including operating system 1205. While executing on processing unit 1202, programming modules 1206 (e.g., application 1220) may perform processes including, for example, one or more of method 200's stages as described above. The aforementioned process is an example, and processing unit 1202 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention includes at least the following aspects:

Aspect 1: A method for determining a multimedia track, the multimedia track comprising an encoding type and at least one of: audio media and video media.

Aspect 2: The method of aspect 1, comprising: receiving a selection to engage a microphone; receiving a signal from the microphone; processing the signal to enable a determination of a multimedia track associated with the signal; wherein processing comprises accessing at least one database, the at least one database may comprise, but not be limited to, at least one of the following: ACRCloud, AcoustID, OneMusicAPI, MusicGraph, Discogs, and Genius; wherein accessing the database comprises accessing the database via an Application Programming Interface (API); determining that the signal is associated with the multimedia track; retrieving data associated with the multimedia track.

Aspect 3: The method of any previous aspect comprising: requesting input from a user, wherein the input comprises at least one of the following: song title, artist, album title;

searching at least one database to determine a multimedia track associated with the receive input; the at least one database may comprise, but not be limited to, at least one of the following: ACRCloud, AcoustID, OneMusicAPI, MusicGraph, Discogs, and Genius; wherein accessing the database comprises accessing the database via an Application Programming Interface (API); determining the multimedia track; and retrieving data associated with the multimedia track.

Aspect 4: The method of any previous aspect, wherein aspect 3 may be triggered when aspect 2 fails to make a determination.

Aspect 5: The method of any previous aspect, wherein aspect 3 may be triggered without the requirement to first trigger aspect 2.

Aspect 6: The method of any previous aspect, wherein aspect 3 may be triggered when aspect 2 makes a determination, but a correction to the determination is desired.

Aspect 7: The method of any previous aspect, further comprising determining bibliographical data associated with the identified multimedia track.

Aspect 8: The method of any previous aspect, wherein determining the bibliographical data comprises determining a plurality of parameters; wherein determining the plurality of parameters comprises accessing the at least one database; the at least one database may comprise, but not be limited to, at least one of the following: ACRCIoud, AcoustID, OneMusicAPI, MusicGraph, Discogs, and Genius; wherein accessing the database comprises accessing the database via an Application Programming Interface (API).

Aspect 9: The method of any previous aspect, further comprising presenting a plurality of parameters associated with bibliographical data of the multimedia track; wherein the plurality of parameters comprise, but are not limited to, at least one of the following: Producers associated with the multimedia track, Artists associated with the multimedia track, Albums associated with the multimedia track, Composers associated with the multimedia track, Engineers associated with the multimedia track, Mixers associated with the multimedia track, Mastering associated with the multimedia track, Recording Studios associated with the multimedia track, Musicians associated with the multimedia track, Record labels associated with the multimedia track, Timelines associated with the multimedia track, Samples associated with the multimedia track, and Interpolations associated with the multimedia track.

Aspect 10: The method of any previous aspect, comprising receiving indications of parameters of interest.

Aspect 11: The method of any previous aspect, further comprising presenting a plurality of options associated with the plurality of parameters in successive order; wherein presenting the plurality of options in successive order comprises: Presenting a first option for selection, Wherein the first option comprises a first parameter associated with the multimedia track, Wherein presenting the first option comprises presenting additional data associated with the first parameter, wherein the additional data comprises, but is not limited to, at least one of the following: A text, Wherein the text comprises a biography of at least one person associated with the first parameter, and An image, Wherein the image comprises a picture of at least one person associated with the first parameter, and Wherein the additional data is retrieved from the at least one database; Receiving a response associated with the first selection option, Wherein the response provides an indication of interest in the first parameter associated with the multimedia track, Wherein the indication of interest comprises, but is not limited to: Interested, Not Interested, or Neither; Presenting a second option for selection, Wherein the second option comprises a second parameter associated with the multimedia track, Wherein presenting the second option comprises presenting additional data associated with the second parameter, Wherein the additional data comprises, but is not limited to, at least one of the following: A text, Wherein the text comprises a biography of at least one person associated with the second parameter, and An image, Wherein the image comprises a picture of at least one person associated with the second parameter, and Wherein the additional data is retrieved from the at least one database; Receiving a response associated with the second selection option, Wherein the response provides an indication of interest in the second parameter associated with the multimedia track, Wherein the indication of interest comprises, but is not limited to: Interested, Not Interested, or Neither; Determining a plurality of parameters of interest based on the received responses associated with the at least one selection option.

Aspect 12: The method of any previous aspect, further comprising presenting a plurality of parameters associated with the multimedia track; enabling a selection of at least one of the plurality of parameters associated with the multimedia track, wherein the selection of the at least one parameter associated with multimedia track indicates an interest for the selected at least one parameter, wherein the selection of the at least one parameter comprises a tagging of the at least one parameter as a parameter of interest, presenting additional data associated with the at least one parameter, Wherein the additional data comprises, but is not limited to, at least one of the following: a text, Wherein the text comprises a biography of at least one person associated with the at least one parameter, and An image, Wherein the image comprises a picture of at least one person associated with the at least one parameter, and Wherein the additional data is retrieved from the at least one database; Determining a plurality of parameters of interest based on the tagged parameters of interest.

Aspect 13: The method of any preceding aspect, wherein aspect 12 may be triggered in sequence to aspect 2; wherein aspect 3 may be triggered without the requirement to first trigger aspect 2.

Aspect 14: The method of any preceding aspect, comprising generating, based at least one parameter of interest, at least one playlist comprised of at least one additional multimedia track.

Aspect 15: The method of any preceding aspect, comprising accessing the at least one database comprising a plurality of multimedia track, the at least one database may comprise, but not be limited to, at least one of the following: ACRCloud, AcoustID, OneMusicAPI, MusicGraph, Discogs, and Genius; wherein accessing the database comprises accessing the database via an Application Programming Interface (API); Determining a plurality of parameters associated with the plurality of multimedia tracks, Wherein the at least one database comprises the plurality of parameters; Matching at least one additional multimedia track when at least a portion of the plurality of parameters corresponds to at least one parameter of interest, Wherein the portion of plurality of parameters corresponds to a threshold match level, Wherein the threshold match level determines how many of the parameters of interest must match with the plurality of parameters corresponding to the at least one additional track in order to consider the at least one additional tracking as a matching track; Aggregating each matched track into at least one playlist, Wherein aggregating each match track into at least one playlist comprises enabling a selection of which parameters of interest to associate with which playlists, Dynamically reorganizing the aggregated tracks in each playlist based on updated selections; Dynamically reorganizing the aggregated tracks in each playlist based on a selection to shuffle the parameters of interest associated with each playlist; Presenting the at least one playlist, Wherein presenting the playlist comprises: enabling a streaming of at least one of the tracks in the playlist, enabling a purchasing of at least one of the tracks in the playlist, enabling a presentation of at least one parameter associated with at least one of the tracks in the playlist, enabling subsequent indications of parameters of interested based on the parameters associated with at least one of the tracks in the playlist, wherein subsequent indications of parameters of interest may be performed in accordance to the embodiments disclosed herein, wherein subsequent indications of parameters of interest may enable the generation of an additional playlist in accordance to the embodiments disclosed herein, displaying additional data associated with at least one of the tracks in the playlist, Wherein the additional data comprises, but is not limited to, at least one of the following: A text, Wherein the text comprises a biography of at least one person associated with the second parameter, and An image, Wherein the image comprises a picture of at least one person associated with the second parameter, and Wherein the additional data is retrieved from the at least one database; Saving the playlist for subsequent retrieval.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

IV. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

Although very narrow claims are presented herein, it should be recognized the scope of this disclosure is much broader than presented by the claims. It is intended that broader claims will be submitted in an application that claims the benefit of priority from this application.

The following is claimed:

1. A method comprising:
receiving input from a user, the input comprising at least one of: a signal from a microphone and text;
processing the input, wherein processing the input comprises accessing at least one database;
determining a multimedia track associated with the input;
retrieving data associated with the multimedia track, wherein retrieving the data associated with the multimedia track comprises retrieving bibliographical data associated with the multimedia track; and
displaying the retrieved data associated with the multimedia track to the user along with the bibliographical data associated with the multimedia track, wherein displaying the retrieved data comprises displaying the bibliographical data as user-selectable parameters,
wherein the user-selectable parameters are configured to indicate, upon selection, at least one of the following:
the user's interest in receiving additional bibliographical data associated with at least one selected parameter of the user-selectable parameters, and
the user's interest in generating a playlist of at least one additional multimedia track based on the at least one selected parameter of the user-selectable parameters.

2. The method of claim 1, wherein retrieving bibliographical data associated with the multimedia track comprises retrieving bibliographical data having a plurality of parameters, each of the plurality of parameters corresponding to a bibliographical data segment of the bibliographical data associated with the multimedia track.

3. The method of claim 1 or 2, wherein accessing the at least one database comprises accessing at least one of the following: a multimedia library, a multimedia track bibliographical text database, ACRCloud, AcoustID, OneMusicAPI, MusicGraph, Discogs, and Genius.

4. The method of claim 1 or 2, wherein accessing the at least one database comprises accessing the at least one database via an Application Programming Interface (API).

5. The method of claim 1, further comprising: presenting, the user, the user-selectable parameters associated with bibliographical data of the multimedia track, wherein the user-selectable parameters comprise, but are not limited to, at least one of the following:
producers associated with the multimedia track,
artists associated with the multimedia track,
albums associated with the multimedia track,
composers associated with the multimedia track,
engineers associated with the multimedia track,
mixers associated with the multimedia track,
mastering associated with the multimedia track,
recording Studios associated with the multimedia track,
musicians associated with the multimedia track,
record labels associated with the multimedia track,
timelines associated with the multimedia track,
samples associated with the multimedia track, and
interpolations associated with the multimedia track.

6. The method of claim 5, wherein presenting, to the user, the user-selectable parameters comprises presenting, as the multimedia track is played-back to the user, each user-selectable parameter representing a bibliographical data segment of the bibliographical data associated with the multimedia track.

7. The method of claim 6, wherein, presenting the user-selectable parameters comprises displaying each user-selectable parameter frame-by-frame, in a successive order.

8. The method of claim 7, wherein displaying each user-selectable parameter further comprises displaying, to the user:
the textual data indicating the bibliographical data segment associated with a currently displayed user-selectable parameter,
a user-selectable portion which, when selected by the user, enable the following:
a display of additional data corresponding to the bibliographical data segment of the multimedia track,
an indication of interest for the at least one additional multimedia track corresponding to the bibliographical data segment for playback to the user, and
a transition to display a subsequent frame comprising a subsequent user-selectable parameter corresponding to a subsequent bibliographical data segment of the bibliographical data associated with the multimedia track.

9. The method of claim 8, further comprising displaying the additional data upon receiving an indication of selection at the user-selectable portion, the additional data comprising, but is not limited to, at least one of the following:
a text, wherein the text comprises a biography of at least one person associated with the bibliographical data segment, and
an image, wherein the image comprises a picture of at least one person associated with the bibliographical data segment, and
wherein the additional data is retrieved from the at least one database.

10. The method of claim 8, further comprising generating a playlist in response to the indication of interest upon receiving an indication of selection at the user-selectable portion, the playlist comprising the at least one additional multimedia track.

11. The method of claim 10, further comprising displaying the at least one additional multimedia track along with a playback software application for user selection.

12. The method of claim 7, further comprising presenting, upon receiving an indication of selection at the user-selectable portion, the subsequent frame comprising the subsequent user-selectable parameter corresponding to the subsequent bibliographical data segment of the bibliographical data associated with the multimedia track, wherein the subsequent user-selectable parameter is presented within the subsequent frame as the multimedia track is played-back to the user.

13. The method of claim 6, wherein presenting, as the multimedia track is played-back to the user, each user-selectable parameter comprises displaying a plurality of user-selectable parameters, each of the plurality of user-selectable parameters being associated with a bibliographical data segment of the bibliographical data associated with the multimedia track.

14. The method of claim 13, further comprising:
receiving a selection of one or more user-selectable parameters of the plurality of user-selectable parameters; and
aggregating the selected one or more user-selectable parameters into a listing of one or more selected parameters.

15. The method of claim 14, further comprising:
generating at least one playlist comprising the at least one additional multimedia track, based on at least a portion of the listing of the one or more selected parameters.

16. The method of claim 15, wherein generating the at least one playlist comprises:
matching the at least one additional multimedia track when at least one bibliographical segment corresponding to the one or more selected parameters corresponds to at least one bibliographical segment of the at least one additional multimedia track,
wherein the portion of plurality of parameters corresponds to a threshold match level, and
aggregating each matched track into the at least one playlist,
wherein a threshold match level determines how many of the bibliographical segments corresponding to the selected one or more parameters must match to the at least one additional track in order to consider the at least one additional tracking as a matching track.

17. The method of claim 15, wherein generating the at least one playlist further comprises:
enabling a selection of which parameters of the listing to associate with which playlists, and
organizing the aggregated tracks into separate playlists based on received parameter selections, and
providing a shuffle feature for dynamically reorganizing the aggregated tracks in each playlist based on a selection to shuffle the parameters associated with each playlist.

18. The method of claim 15, further comprising:
presenting the at least one playlist; and
enabling at least one of:
a streaming of at least one of the tracks in the at least one playlist,
an exporting of the at least one playlist,
a sharing of the at least one playlist,
a presentation of at least one parameter associated with at least one of the tracks in the at least one playlist,
a selection of subsequent indications of parameters based on subsequent bibliographical segments based on the parameters associated with at least one of the tracks in the at least one playlist, wherein subsequent indications of parameters enables the generation of at least one additional playlist, and a saving of at least one playlist for subsequent retrieval,
generating at least one smart playlist based at least on: prior user input, prior selections of parameters, and one or more tracks in at least one saved playlist.

19. The method of claim 5, further comprising:
selecting a multimedia track;
selecting a parameter associated with bibliographical data of the selected multimedia track;
requesting a user profile associated with the selected parameter, the user profile comprising at least one of:
a producer associated with the selected parameter,
an artist associated with the selected parameter,
a music professional associated with the selected parameter,
a composer associated with the selected parameter,
an engineer associated with the selected parameter,
a mixer associated with the selected parameter,
a recording Studio associated with the selected parameter, and
a musician associated with the selected parameter; and
presenting the requested user profile.

20. The method of claim 15, further comprising:
selecting a multimedia track from at least one playlist;
selecting a parameter associated with the bibliographical data segment of the selected multimedia track;
requesting a user profile associated with the selected parameter, the user profile comprising at least one of:
a producer associated with the selected parameter,
an artist associated with the selected parameter,
a music professional associated with the selected parameter,
a composer associated with the selected parameter,
an engineer associated with the selected parameter,
a mixer associated with the selected parameter,
a recording Studio associated with the selected parameter, and
a musician associated with the selected parameter; and
presenting the requested user profile.
